(19) United States
(12) Patent Application Publication
(10) Pub. No.: US 2008/0288425 A1
(43) Pub. Date: Nov. 20, 2008

(54) Methods and Apparatus for Reasoning About Information Fusion Approaches

(76) Inventors: Christian Posse, Seattle, WA (US); Nathaniel Beagley, Richland, WA (US); Jorge F. Reyes Spindola, Richland, WA (US); Stephen C. Tratz, Richland, WA (US); Amanda M. White, Kennewick, WA (US)

Correspondence Address: BATTELLE MEMORIAL INSTITUTE;ATTN: IP SERVICES, K1-53, P. O. BOX 999, RICHLAND, WA, 99352, US

(21) Appl. No.: 11/749,916

(22) Filed: May 17, 2007

(51) Int. Cl. G06F 15/18

(52) U.S. Cl. 706/12

(57) ABSTRACT

Methods and apparatus for reasoning about information fusion approaches are described according to some aspects. In one aspect, a method for reasoning about information fusion approaches comprises selecting one or more information fusion approaches for evaluation, and applying the approaches to two or more sets of data. The selection of information fusion approaches can be based on a taxonomy that classifies information fusion algorithms. The impact of each of the applied information fusion approaches can then be conveyed to a user, wherein the conveyed impact is based on one or more impact measures.

This invention was made with Government support under Contract DE-AC0576RL01830 awarded by the U.S. Department of Energy. The Government has certain rights in the invention.

### BACKGROUND

Information fusion can involve fusing data extracted from multiple, distributed, and/or heterogeneous data sources and is increasingly recognized as being beneficial for key tasks such as detection, recognition, identification, tracking, change detection, decision making, and prediction. In spite of a significant progress in research on information fusion, there are still very few formal frameworks for defining various types of information fusion systems, for defining and analyzing relations among such types, and for designing information fusion systems using a formal method approach. Consequently, traditional fused systems tend to be poorly understood “black boxes” and are often ad-hoc solutions. Furthermore, the traditional fused systems tend to neglect the effects of the user and the human element in information fusion.

Two recent formalizations have been described by Kokar et al. (“Formalizing Classes of Information Fusion Systems.” Information Fusion (5):189-202, 2004.) and by Thorsen and Oxley (“Comparing Fusors within a Category of Fusors.” Proceedings of the 7^{th} International Conference on Information Fusion, pg. 435-441, 2004. and “Fusion and Integration. What's the Difference?” Proceedings of the 7^{th} International Conference on Information Fusion, pg. 429-434, 2004.). However, both formalizations rely primarily on advanced mathematics and do not appear to currently provide practical solutions for conveniently reasoning about fusion approaches. Accordingly, a need exists for apparatus and computer-implemented methods for reasoning about and for applying information fusion approaches in a user-centric manner.

### DESCRIPTION OF DRAWINGS

Embodiments of the invention are described below with reference to the following accompanying drawings.

FIG. 1 is an illustration of a taxonomy of fusion approaches according to one embodiment of the present invention.

FIGS. 2a and 2b are scatterplots showing exemplary IN-SPIRE™-generated clustering results as a function of an enrichment parameter.

FIG. 2c is an exemplary impact plot showing fusion impact as a function of enrichment.

FIG. 3 is a block diagram of an embodiment of an apparatus for reasoning about information fusion approaches.

FIG. 4 shows examples of results of IN-SPIRE™ analyses of six different fusion approaches at a particular enrichment parameter value.

FIG. 5 is an embodiment of a visualization comprising a JUXTER graph.

FIG. 6 shows exemplary impact plots comparing two different enrichment processes.

### DETAILED DESCRIPTION

At least some aspects of the disclosure provide apparatus and computer-implemented methods for selecting one or more information fusion approaches and conveying to a user the impact of the application of each of the fusion approaches to two or more sets of data. Exemplary selecting can be based, at least in part, on a taxonomy that classifies information fusion algorithms. Accordingly, the apparatus and methods described herein can facilitate effective application of a particular information fusion approach by providing a user a means of reasoning about a variety of information fusion approaches.

As used herein, “sets of data” and “datasets,” can refer to bodies of processor-usable information that are intended to be fused according to an information fusion approach. Exemplary datasets can comprise, at least in part, information including, but not limited to, sensor data, text-based correspondence (e.g., emails, chat room communications, instant messages, cellular phone text messages, etc.), communication transcripts, publications (e.g., newspaper articles, magazine articles, books, websites, blogs, etc.), intelligence reports, imagery (satellite photos, surveillance images, videos, photographs, etc.), and maps. The datasets can comprise raw data received substantially directly from a data source (e.g., as-received documents, data from a sensor, etc.) or the datasets can comprise data that has been manipulated by processing circuitry. An example of data that have been manipulated can include, but is not limited to, computer-processable information that has been characterized by one or more information analysis techniques. Exemplary information analysis techniques can include, but are not limited to, data mining and pattern recognition techniques, statistical analyses, and visual analytics techniques. Accordingly, in one embodiment, at least a portion of one or more datasets can comprise one or more data signatures. Data signatures, as used herein, can refer to rich mathematical representations of the data including, but not limited to, structural signatures, lexicon-based signatures, statistical signatures, ontology-based signatures, and semantic social network signatures.

As used herein, a taxonomy can refer to a hierarchical organization of information fusion algorithms. While some taxonomies of fusion algorithms already exist, and are compatible with embodiments of the present invention, they may not be optimal because many of the currently-known taxonomies 1) are expressed primarily in common language instead of mathematics, making it difficult to quantitatively assess and compare alternative fusion approaches, 2) do not emphasize users' interaction with the fusion algorithms and only marginally improve users' cognitive understanding, and/or 3) have tended to neglect a constraint that often arises, wherein the fused dataset must be structurally identical to one of the datasets to be fused, referred hereafter as the “reference” dataset The constraint wherein the fused dataset must be structurally identical to one of the datasets to be fused can apply, for example, when an advanced analytical environment has been developed for a given dataset and fusing it with other sets of data without the above constraint would entail expensive reconstruction of the original environment. Accordingly, in one embodiment, the taxonomy comprises a distinction between fusion algorithms for constrained and unconstrained datasets. Symmetric fusion can involve unconstrained datasets and can be addressed by existing taxonomies. Asymmetric fusion can address constrained sets of data, and can involve modification of at least some characteristics of the reference dataset, or fusion operations associated with the reference dataset, to enable fusion with other datasets.

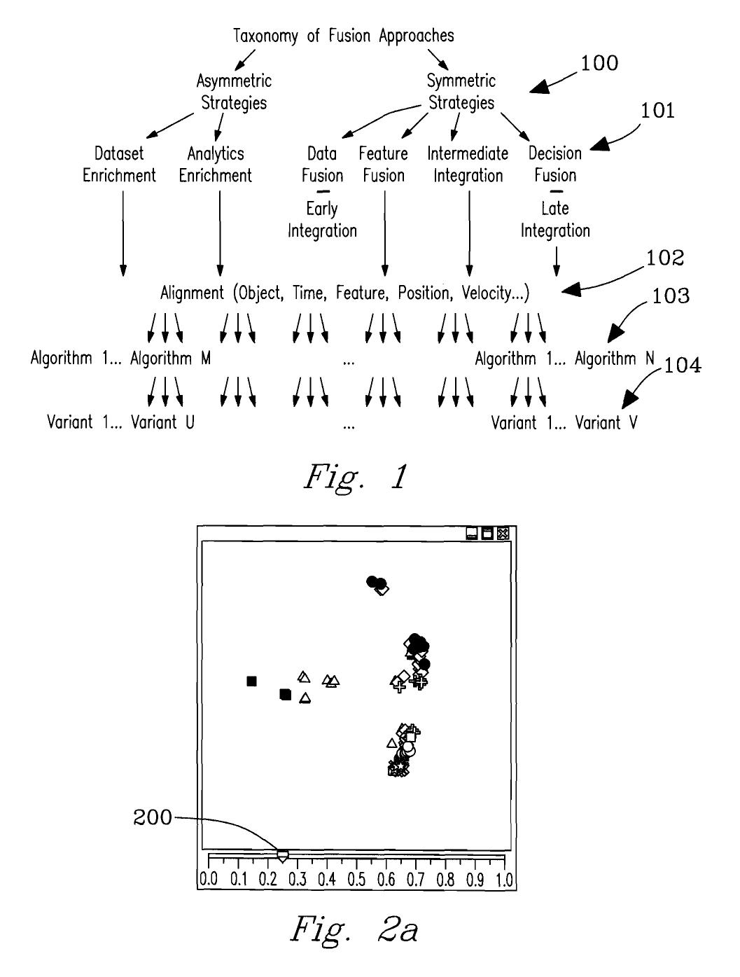

Referring to FIG. 1, an illustration depicts one embodiment of a taxonomy having five levels. The top four levels of the taxonomy can be considered generic and the fifth level can be considered implementation specific. At the first level 100 of the taxonomy, a distinction is made between symmetric (i.e., unconstrained datasets) and asymmetric (i.e., constrained datasets) data classes of fusion processes. Fusion processes comprise classes of fusion algorithms and can be viewed as a second level 101 in the taxonomy. Alignment requirements can be viewed as a third level 102 in the taxonomy, while fusion algorithms can be viewed as a fourth level 103. Implementation variants, a fifth level 104 in the taxonomy, comprise fusion algorithms that have been adapted, at least in part, for a specific implementation and/or to address particular fusion applications. Accordingly, the variants are arranged in classes, each associated with the particular fusion algorithm from which they are based.

Fusion processes classified in the taxonomy as asymmetric can apply to sets of data that are constrained and can be arranged, for example, as dataset enrichment processes and analytics enrichment processes. Fusion algorithms classified under dataset enrichment processes can alter values of the reference dataset. Algorithms classified under analytics enrichment processes can alter the metrics and/or operators associated with the reference dataset. Analytics enrichment processes are enabled by the fact that any analytical task (e.g., clustering, classification, prediction, outlier detection, etc.) on datasets can be described mathematically in terms of a specific metric acting upon the datasets. Therefore, enrichment by other datasets can be applied to the metric itself, rather than to the datasets. One example of this includes replacing the Euclidean distance for vector-based signatures with reweighted versions of the Euclidean distance, where the weights are determined from information not contained in the vector-based signatures.

As described in greater detail elsewhere herein, the processes associated with asymmetric fusion can facilitate generation of dynamic representations of the fusion impact that enable users to first understand and assess the impact and then control the degree of fusion or enrichment. Accordingly, in one embodiment, the degree of enrichment can be varied when employing asymmetric fusion processes.

Fusion processes classified in the taxonomy as symmetric can apply to sets of data that are unconstrained and, in some embodiments, can be further arranged in a manner similar to other known taxonomies and classes of information fusion algorithms. In one instance, fusion processes can correspond to known classes of fusion algorithms, which can include, but are not limited to, data fusion (also called early integration), feature fusion, intermediate integration and decision fusion (also called late integration) classes.

The data fusion class can comprise fusion algorithms that combine the original source datasets before passing them to analysis. The feature fusion class can comprise algorithms that first extract common features from the source datasets, combine the common features, and finally pass the results to an analytical tool. The intermediate integration class can comprise algorithms that create a dissimilarity matrix between objects from each source dataset, combine the dissimilarity matrices, and then pass the results to an analytical tool. The decision fusion class can comprise fusion algorithms that apply some analysis to each source dataset and then combine the results of the analyses. Additional details regarding data fusion, feature fusion, intermediate fusion, decision fusion and/or other known classes of fusion algorithms can be found elsewhere herein and in Mathematical Techniques in Multisensor Data Fusion by Hall and McMullen (Second Edition, Artech House Information Warfare Library, 2004), as well as in Decision Fusion by Dasarathy (New York, N.Y.: IEEE Computer Society Press, 1994), which details are incorporated herein by reference.

In one embodiment, the second level of the taxonomy (e.g., data fusion, feature fusion, intermediate integration, decision fusion, dataset enrichment, analytics enrichment, etc.) can be described according to a formalization in terms of the parameterization of a multidimensional path in dataset or operator spaces. For the sake of brevity and without loss of generality, exemplary formalizations can be presented using a simple case wherein only two datasets are involved and the fusion system is fixed over time (i.e., non-adaptive). However, the scope of the present invention can encompass involvement of greater than two datasets and/or adaptive fusion systems.

In the instant exemplary formalization, let α and β denote the two source datasets, which may be defined on different objects. Since not all signatures may have the same relevance for the fusion task, an importance weight ω_{α} (ω_{β}) is associated with each signature α (β). Let A (B) denote the space on which α (β) is defined. Finally, let M_{α} denote a metric defined on A. In the case of analytics enrichment, M_{α} will be enriched with information contained in β.

Dataset enrichment of a reference dataset, α, by an enriching dataset, β, can be defined by the mapping

I_{E1}:[0,1]→A

η→I_{E1}(η)=α⁺(β,η)

where I_{E1}(0)=α⁺(β,0)=α.

The mapping, I_{E1}, can be interpreted as the parameterization of a path in space A, starting at the reference dataset α and ending at the fully enriched dataset α⁺(β,1). The enrichment parameter, η, controls the amount of enrichment. The path trajectories depend on the enrichment algorithms described later in this section. The above definition can lead to dynamic visual representations of the enrichment impact. For example, a user can control the enrichment parameter, η, via a graphical representation of a slider. By moving along the path trajectory induced by the enrichment algorithm, the user can witness how results change with different levels of enrichment.

In some instances, it is possible to augment the dimension of the reference dataset without changing its structure so that the resulting augmented dataset can still be fed to its analytical environment. This can provide flexibility for defining enrichment algorithms and can lead to the following generalization. Dataset enrichment of α by β in the augmented space can be defined by the mapping

I_{E2}:[0,1]→A×A⁺

η→I_{E2}(η)=α⁺(β,η)

where I_{E2}(0)=(α,0). If A⁺=0, this is reduced to the previous mapping, I_{E1}.

Analytics enrichment can be defined by the mapping

I_{M}:[0,1]→A×A

η→I_{M}(η)=M_{α}⁺(β,η)

where I_{M}(0)=M_{α}. The mapping can be interpreted as the parameterization of a path in space A×A, whose trajectories are determined by specific analytics enrichment algorithms.

Data fusion of α and β can be defined by the mapping

I_{Da}:[0,1]→S

η→I_{Dα}(η)=I_{Dα}(α,β,η)

where I_{Dα}(0)=α and I_{Dα}(1)=β, and S denotes the space of the fused dataset, which includes A and B.

Feature fusion, intermediate integration and decision fusion of α and β can each be defined by the mapping

I_{F}:[0,1]→S

η→I_{F}(η)=I_{C}(I_{A→C}(α),I_{B→C}(β),η),

where I_{F}(0)=I_{A→C}(α), I_{F}(1)=I_{B→C}(β), and S is the space of fused information. In the case of feature fusion, I_{A→C}(α) (I_{B→C}(β)) denotes the common features extracted from α (β) and C denotes the space of common features. In the case of intermediate integration, I_{A→C}(α) denotes the dissimilarity matrix between α-objects and C denotes the space of dissimilarity matrices, while in the case of decision fusion, I_{A→C}(α) denotes the result of the analytical process applied to α, and C denotes the result space.

### Example: Algorithms Templates for Dataset Enrichment Processes

Dataset enrichment algorithms can be categorized into three templates that distinguish the part of the enrichment provided by β that is found in A: all, partial, or none. The “all” template makes use of the first definition of signature enrichment, forcing the projection of β into A, while the remaining two use the second definition, which considers the augmented space A×A⁺.

### All—Algorithm Template for Dataset Enrichment

1. Align β-objects with α-objects if necessary: (β,ω)→β₁

2. Map β₁ into A space: β₂=I_{B→A}(β₁), normalize if needed

3. Extract enrichment: β_{α}=β₂−α

4. Enrich α: α⁺(β,η)=F(α+ηβ_{αx)}

### Partial—Algorithm Template for Dataset Enrichment

1. Align β-objects with α-objects if necessary: (β,ω)→β₁

2. Map β₁ into A×A⁺ space: β₂=(β₂₁,β₂₂)=I_{B→A×A+}(β₁), normalize if needed

3. Extract enrichment: β_{α}=(β_{α1},βα₂)=(β₂₁−α, β₂₂)

4. Enrich α: α⁺(β, η)=F((α+ηβ_{α1}, ηβ_{α2}))

### None—Algorithm Template for Dataset Enrichment

1. Align β-objects with α-objects if necessary: (β, ω)→β₁

2. Map β₁ into A⁺ space: β₂=I_{B→A+}(β₁), normalize if needed

3. Enrich α: α⁺(β, η)=F((α, ηβ_{α}))

### Example: Algorithms Templates for Analytics Enrichment Processes

1. Map β into A space: β₁=I_{B→A}(β)

2. Compute normalized similarity matrix R in A×A based on (β₁, ω_{β}). Examples of such matrix include correlation matrix and cosine-based similarity matrix

3. Enrich M_{α} with R. Examples of enrichment include the linear path: Mₐ⁺(β, η)=(1−η)M_{α}+ηR, the geodesic path, and the Choleski path: M_{α}⁺(β, η)=V^{η}M_{α}^{(1-η})(V^{T})^{η} where V is the Choleski decomposition matrix of R. Details regarding geodesic paths are described by Buja et al. (“dynamic projections in high-dimensional visualization: theory and computational methods,” Technical Report, AT&T Labs, Florham Park, N.J., 1997), which details are incorporated herein by reference.

In the context of fusion processes, being between 0 and 1, η can be interpreted as an enriching weight controlling the enrichment of α and β. In one embodiment, the value of η can be manually controlled by a user via a graphical representation on a display device. Examples of a graphical representation can include, but are not limited to, a slider, a rotating dial, and a button that produces incremental changes when depressed. Alternatively, the q values can be automatically varied and the resultant impact automatically displayed on a display device. One example of automatically varying the η values can include, but is not limited to, automatically incrementing through the range of q values at a given rate. Ultimately, controlling and varying the value of η can allow the user to understand, assess, and determine the degree and, therefore, the impact, of the enrichment. It can further provide a data-driven means of optimizing the degree of enrichment and, therefore, the appropriateness of the fusion approach.

The enrichment parameter, η, can also be applied to provide the ability to dynamically convey the impacts of applied information fusion approaches. For example, when fusing datasets the enrichment parameter can be applied, as described elsewhere herein, as a “wrapper” by calculating solutions for a plurality of different η values for each fusion approach.

In some embodiments, the taxonomy can further comprise an additional layer arranging fusion algorithms into classes based on the need for, and/or the type of, alignment associated with the algorithm. Accordingly, the alignment classes can be classes of fusion algorithms, and fusion processes can comprise classes of alignments. Alignment, as used herein, can refer to a process of transforming the datasets to a common coordinate system (e.g., geographical space and/or time) wherein heterogeneous (i.e., non-commensurate) source datasets, as well as the global knowledge, can be represented. Exemplary source dataset characteristics that may be non-commensurate can include, but are not limited to the objects on which the datasets are defined, dataset features, and the time, location and velocity at which the datasets were recorded.

As used herein, an information fusion approach can refer to the overall approach adopted during fusion of a plurality of sets of data. Each information fusion approach can be defined, at least in part, as a path through a taxonomy along associated classes in the taxonomy. For example, in one embodiment, wherein the taxonomy resembles the embodiment described in FIG. 1, each of a plurality of information fusion approaches can comprise a particular fusion constraint type (e.g., symmetric or asymmetric), fusion process, alignment, fusion algorithm, and implementation variant. It is, therefore, understood and encompassed by the scope of the present invention, that different taxonomies can result in slightly different definitions of information fusion approaches.

In one embodiment, reasoning about information fusion approaches comprises selecting one or more information fusion approaches for evaluation, and applying them to two or more sets of data. The selection of information fusion approaches can be based on a taxonomy that classifies information fusion algorithms. The impact of each of the applied information fusion approaches can then be conveyed to a user, wherein the conveyed impact is based on one or more impact measures.

Selection of the information fusion approaches can be automated, user assisted, user-determined, or combinations thereof. Exemplary automated selection can be based on a one or more processor-usable policies and rules. Alternatively, selection of the information approaches can be determined by a user. Further still, the selection can be user assisted, wherein the user provides input and interacts with a computing device, which can apply one or more processor-usable policies and rules, to select the information fusion approaches that will be evaluated.

In one embodiment, selection of the information fusion approaches, whether automated, user determined, or user-assisted, can comprise selecting from a group of available fusion approaches according to one or more criteria such that the information fusion approach is compatible with the datasets and/or the approach is potentially appropriate for a particular application. An exemplary criterion for selection of information fusion approaches can include, but is not limited to, the pedigree of the sets of data to be fused and/or the data composing those sets of data. In the context of data, pedigree, as used herein, can refer to qualities of the data such as its source, nature, and/or characteristics. Exemplary qualities include, but are not limited to, the distributed nature of the data, the presence and amount of noise, the reliability of the data, the type of objects on which the data are defined, the complexity of the data, etc.

Accordingly, one example of selecting an information fusion approach based on pedigree can include the selection of either asymmetric fusion for constrained datasets or symmetric fusion for unconstrained datasets. Another example can be based on the existence of a distributed environment, where there is no common server. Under these circumstances, access to full datasets might not be possible, but analytical results based on those datasets might be available. Situations like this preclude the implementation of data fusion processes and might arise between two entities who are unwilling to share data, but are willing to share results. Results-oriented fusion algorithms (e.g., decision fusion) are, therefore, the appropriate fusion approaches. In yet another example, the level and nature of missing data in the source datasets may suggest an information fusion approach involving either data fusion processes, wherein the missing data is first imputed, or decision fusion processes, if imputation is not possible. Exemplary imputation can comprise substituting missing data with estimates using information from other datasets.

In another embodiment, the criterion for selection of information fusion approaches can be based on the similarity of the various sets of data to be fused. For example, regarding algorithms classified under symmetric fusion, when the datasets are alike, data fusion processes can be preferred as they take all the data into account. Decision fusion processes can be more suitable and computationally more efficient when the source datasets are very different. Feature fusion can require the ability to identify common features between the datasets. Intermediate integration can be simpler, however, it may require additional processing if the analytical tool to be applied does not support dissimilarity matrices as inputs.

In one embodiment, application of each of the selected information fusion approaches to sets of data can comprise traversing the taxonomy along a path of associated classes to a fusion implementation variant of a particular fusion algorithm and applying the implementation variant to the sets of data. Application of a plurality of information fusion approaches to the same sets of data can allow the different fusion approaches to be evaluated and compared in terms of their respective influence on the information fusion results.

In some embodiments, a single information fusion approach can be evaluated in terms of the impact that the degree of application has on the fusion results. For example, when employing a fusion algorithm that is associated with asymmetric fusion processes, various degrees of enrichment of one dataset with another using a single algorithm can be compared one with another. Similarly, when employing a particular fusion algorithm that is associated with symmetric fusion processes, various degrees of mixing at least two datasets using a single algorithm can be compared one with another. Exemplary control of the degrees of enrichment and/or mixing can be provided, as described elsewhere herein, by an enrichment parameter, η, applied to one or more analytical operators or to at least one of the sets of data.

Reasoning about a particular set of competing information fusion approaches can comprise understanding and comparing one with another, and selecting an appropriate approach to apply. When a gold standard solution exists (e.g. supervised learning setting), the selection of an optimal fusion approach may essentially be based on the approach's performance. Other factors such as the robustness of the impact of a fusion approach may also play a role in the decision. Without a gold standard, the impact becomes a dominant selection factor. The type and availability of impact assessment tools depend on the analysis under consideration and the symmetry of the fusion strategies. Exemplary impact measures can include, but are not limited to individual and global changes of signature locations and individual and global changes in cluster memberships.

In one embodiment, with regard to asymmetric fusion processes, optimal fusion and/or enrichment can be described in the context of clustering applications. The measure of the impact can depend, at least in part, on the enrichment parameter, η, and the assessments can automatically update when η changes values. For example, the impact of a particular enrichment can be measured both before and after having clustered the enriched datasets. If before clustering, the impact can be assessed by measuring the displacement of the datasets generated by the enrichment (i.e. by comparing α=α⁺(β, 0) and α⁺(β, η)). The comparison can be done at the individual level to understand the local impact of the enrichment and at the global level, based on all datasets, when comparing different fusion approaches. An exemplary global displacement measure considers the relative changes in pairwise distances between signatures, and is given by

GD(η)=(Σ_{k>1}|d(αₖ,α₁)−d(αₖ⁺(β,η),α₁⁺(β,η))|)/Σ_{k>1}d(αₖ,α₁)

where d is any suitable distance measure in A.

Measuring the impact of an enrichment after having clustered the signatures can be done using traditional comparative tools such as confusion matrices or more powerful visual representations such as a Juxter graph, a parallel coordinate dynamic plot for discrete data.

The amount of available enrichment for a given strategy can be measured by the maximum value of the global displacement measure, e.g. GDmax=max_{η} GD(η). One way to estimate an optimal enrichment is to analyze the global displacement produced by a given amount of enrichment. For example, consider the ratio, GD(η)/(1+η). The value, η*, maximizing this ratio corresponds to the case of maximum perturbation with minimum enrichment. The triplet (GDmax, η*, GD(η*)/(1+η*)) efficiently summarizes the information needed for comparing and ranking enrichment strategies, including which strategy has the fastest impact and makes the most use of the available enrichment.

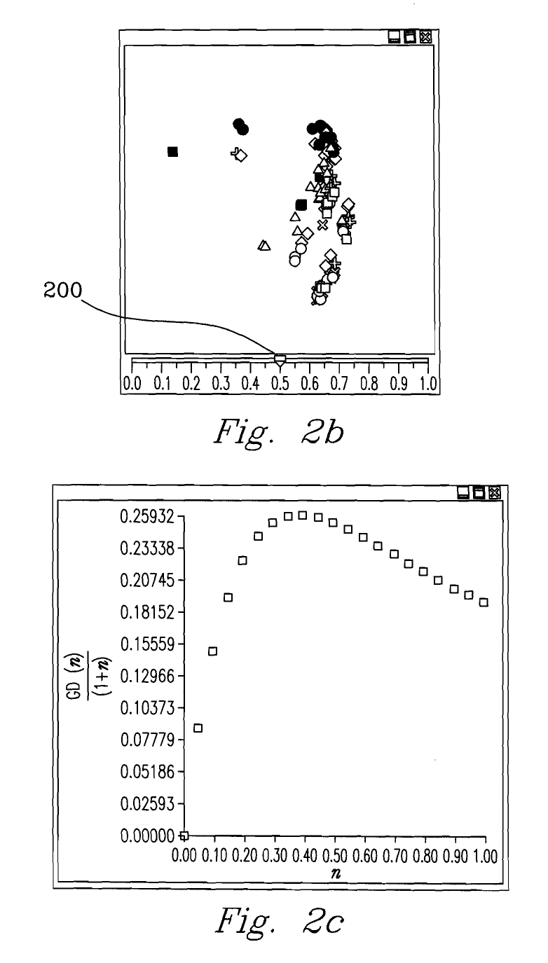

In one example of using the global displacement measure as an impact measure, referring to FIGS. 2a and 2b, scatter plots generated by IN-SPIRE™, a visual environment for exploring textual data. IN-SPIRE™ relies on statistical analysis for generating and clustering vector-based document signatures. The scatter plots comprise IN-SPIRE™ associations of a body of documents enriched with another dataset using a fusion algorithm classified as a signature enrichment process. Additional details regarding IN-SPIRE™ are described by Hetzler and Turner (“Analysis experiences using information visualization,” IEEE Computer Graphics and Applications, vol. 24, no. 5, pp. 22-26, 2004), by U.S. Pat. Nos. 7,113,958, 6,298,174, and 6,584,220, and by U.S. patent application Ser. No. 11/535,360, which details are incorporated herein by reference. FIG. 2a shows the results when η is 0.25 and FIG. 2b shows the results when η is 0.5. Each point on the plot represents a document and the documents are clustered according to topics. Related documents, therefore, appear spatially closer to one another compared to unrelated documents. The clustering structure of the scatterplot changes based on the degree of enrichment applied to the datasets, as can be seen by the differences between FIGS. 2a and 2b. For various degrees of enrichment (i.e., each value of η), the change in structure can be measured by the global displacement as described elsewhere herein. The range of η values can be selected by a graphical representation of a slider 200. Referring to FIG. 2c, an impact plot shows the change in structure, or the impact, as a function of η values. The peak in the plot can then be interpreted, in the instant embodiment, as the optimum η value and the fusion algorithm can be applied accordingly.

In one embodiment, when conveying to a user the impact of the applied information fusion approaches the impacts from a plurality of approaches can be conveyed substantially in parallel (i.e., simultaneously and/or side-by-side), which facilitates direct comparison of two or more fusion approaches. Furthermore, the impact can be conveyed substantially in real-time relative to the application of fusion algorithms and/or the adjustment of parameters and variables associated with the fusion algorithms. Further still, conveying an impact can comprise generating a visual representation of the impact. The visual representation can be dynamic or static. One example of a dynamic visual representation can include graphical representations of the impact from each information fusion approach that are animated to morph from one to the other. One example of a dynamic, real-time visual representation can include, as described elsewhere herein, updating the conveyed impact in real-time as a fusion operation and/or parameter is varied (e.g., the enrichment parameter is altered when employing algorithms classified under asymmetric fusion). An example of a static visual representation can include a representation that corresponds to a particular fusion solution or a given value of degree of enrichment or mixing.

Visual representations, as used herein, can refer to graphs, plots, maps, images, visualization metaphors, and other graphic constructions that can be displayed on a display device. Exemplary visual representations can include, but are not limited to, scatter plots (e.g., impact plots), cluster graphs, IN-SPIRE™ galaxy plots, and JUXTER graphs, respectively. JUXTER graphs comprise parallel coordinate displays and are generated by the Categorical Juxtaposer, a general-purpose visualization metaphor that depicts categorical information to support recognition and comparison of patterns across categorizations developed at Pacific Northwest National Laboratory in Richland, Wash. An additional type of representation includes a plot of geodesic path distances between datasets to be fused (symmetric dataset fusion), original and enriched datasets (e.g., dataset enrichment processes), or original and enriched metrics (e.g., analytics enrichment processes).

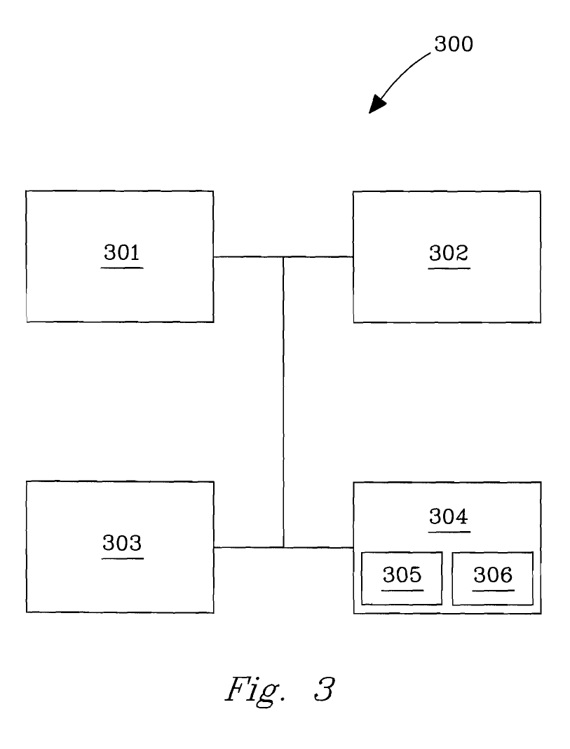

Referring to FIG. 3, an exemplary apparatus 300 for reasoning about information fusion approaches is illustrated. In the depicted embodiment, the apparatus is implemented as a computing device such as a work station, server, handheld computing device, or personal computer, and can include a communications interface 301, processing circuitry 302, storage circuitry 303, and, in some instances, a user interface 304. Other embodiments of apparatus 300 can include more, less, and/or alternative components.

The communications interface 301 is arranged to implement communications of apparatus 300 with respect to a network, the internet, an external device, a remote data store, etc. Communications interface 301 can be implemented as a network interface card, serial connection, parallel connection, USB port, SCSI host bus adapter, Firewire interface, flash memory interface, floppy disk drive, wireless networking interface, PC card interface, PCI interface, IDE interface, SATA interface, or any other suitable arrangement for communicating with respect to apparatus 300. Accordingly, communications interface 301 can be arranged, for example, to communicate information bi-directionally with respect to apparatus 300.

In an exemplary embodiment, communications interface 301 can interconnect apparatus 300 to one or more persistent data stores having information including, but not limited to, taxonomies, sets of data to be fused, information fusion algorithms, and information analytics algorithms stored thereon. The data store can be locally attached to apparatus 300 or it can be remotely attached via a wireless and/or wired connection through communications interface 301. For example, the communications interface 301 can facilitate access and retrieval of datasets to be fused from one or more data stores containing processor-usable information.

In another embodiment, processing circuitry 302 is arranged to execute computer-readable instructions, process data, control data access and storage, issue commands, perform calculations, and control other desired operations. Processing circuitry 302 can operate to select one or more information fusion approaches for evaluation, wherein the selection is based on a taxonomy that classifies information fusion algorithms. The processing circuitry 302 can further operate to apply one or more of the selected information fusion approaches to two or more sets of data and to convey to a user the impact of each of the applied information fusion approaches. The conveyed impact can be based on one or more impact measures.

Processing circuitry can comprise circuitry configured to implement desired programming provided by appropriate media in at least one embodiment. For example, the processing circuitry 302 can be implemented as one or more of a processor, and/or other structure, configured to execute computer-executable instructions including, but not limited to software, middleware, and/or firmware instructions, and/or hardware circuitry. Exemplary embodiments of processing circuitry 302 can include hardware logic, PGA, FPGA, ASIC, state machines, an/or other structures alone or in combination with a processor. The examples of processing circuitry described herein are for illustration and other configurations are both possible and appropriate.

Storage circuitry 303 can be configured to store programming such as executable code or instructions (e.g., software, middleware, and/or firmware), electronic data (e.g., electronic files, databases, data items, etc.), and/or other digital information and can include, but is not limited to, processor-usable media. Exemplary programming can include, but is not limited to programming configured to cause apparatus 300 to facilitate the reasoning about information fusion approaches, as described elsewhere herein. Processor-usable media can include, but is not limited to, any computer program product, data store, or article of manufacture that can contain, store, or maintain programming, data, and/or digital information for use by, or in connection with, an instruction execution system including the processing circuitry 302 in the exemplary embodiments described herein. Generally, exemplary processor-usable media can refer to electronic, magnetic, optical, electromagnetic, infrared, or semiconductor media. More specifically, examples of processor-usable media can include, but are not limited to floppy diskettes, zip disks, hard drives, random access memory, compact discs, and digital versatile discs.

At least some embodiments or aspects described herein can be implemented using programming configured to control appropriate processing circuitry and stored within appropriate storage circuitry and/or communicated via a network or via other transmission media. For example, programming can be provided via appropriate media, which can include articles of manufacture, and/or embodied within a data signal (e.g., modulated carrier waves, data packets, digital representations, etc.) communicated via an appropriate transmission medium. Such a transmission medium can include a communication network (e.g., the internet and/or a private network), wired electrical connection, optical connection, and/or electromagnetic energy, for example, via a communications interface, or provided using other appropriate communication structures or media. Exemplary programming, including processor-usable code, can be communicated as a data signal embodied in a carrier wave, in but one example.

User interface 304 can be configured to interact with a user and/or administrator, including conveying information to the user (e.g., displaying data for observation by the user, audibly communicating data to the user, etc.) and/or receiving inputs from the user (e.g., tactile inputs, voice instructions, etc.). Accordingly, in one exemplary embodiment, the user interface 304 can include a display device 305 configured to depict visual information, and a keyboard, mouse and/or other input device 306. Examples of a display device include cathode ray tubes, plasma displays, and LCDs.

The embodiment shown in FIG. 3 can be an integrated unit configured for reasoning about information fusion approaches. Other configurations are possible, wherein apparatus 300 is configured as a networked server and one or more clients are configured to access the processing circuitry and/or storage circuitry for accessing datasets to be fused, accessing taxonomies of fusion algorithms, selecting and applying information fusion approaches to the datasets, generating visualizations of fusion impacts, conveying impacts to a user, and receiving input from a user.

Example: A Case Study for Reasoning about Information Fusion Approaches

At the turn of the century, Southeast Asia experienced a wave of terrorist attacks that have been linked to Jemaah Islamiah (JI), a militant Islamic terrorist group. These events were tracked by The Foreign Broadcast Information Service (FBIS), a United States government operation which translates the text of daily broadcasts, government statements, and select news stories from non-English sources around the world. 126 FBIS documents reporting on these events between October and December 2002 were selected by intelligence analysts and analyzed with IN-SPIRE™.

IN-SPIRE™ relies on statistical analysis for generating and clustering vector-based document signatures. A limitation of statistical signatures is that they tend to underestimate the importance of entities (e.g., people, organizations) and ties between them. A limitation of vector-based signatures is that the key concepts associated with the vector components are usually treated as if they are not correlated. However, an inspection of the IN-SPIRE™ key concepts induced by the set of FBIS documents reveals the presence of concepts such as “car”, “bombing”, “East”, “West”, “JI” and “al-Qaeda”, concepts that are obviously not independent.

Intelligence analysts were interested in enriching the IN-SPIRE™ analysis with social network information contained in the set of FBIS documents. In the instant example, a method proposed by Wong et al. (Information Visualization, vol. 5, no. 4, pp. 237-249, 2006) was used for generating role profiling signatures for the entities mentioned in the FBIS documents and is incorporated herein by reference. Using a single scan of the documents and natural language processing, the method automatically extracts named entities, events involving these entities as well as the context in which these events take place. The extraction resulted in about five hundred entity-based signatures. 180 signatures associated with terrorists and terrorist suspects were selected to enrich the IN-SPIRE™ analysis.

According to embodiments of the present invention, six enrichment variants were defined, five for dataset enrichment and one for analytics enrichment. Three of the five dataset enrichment variants corresponded to the “all” dataset enrichment strategy, one variant corresponded to the “partial” strategy and one variant corresponded to the “none” strategy. Hence, these six variants allowed us to compare fusion approaches at levels 2, 4 and 5 of the taxonomy. The six variants were also clustered a priori based on the similarity of their algorithm. This would allow us to investigate the relationship between algorithm similarity and solution similarity. It was devised that the sixth variant (for analytics enrichment) would be different from the other variants. The first five variants represented incremental changes in the fusion algorithm from the first to the fifth variant and it was expected that this order would be preserved in the solutions.

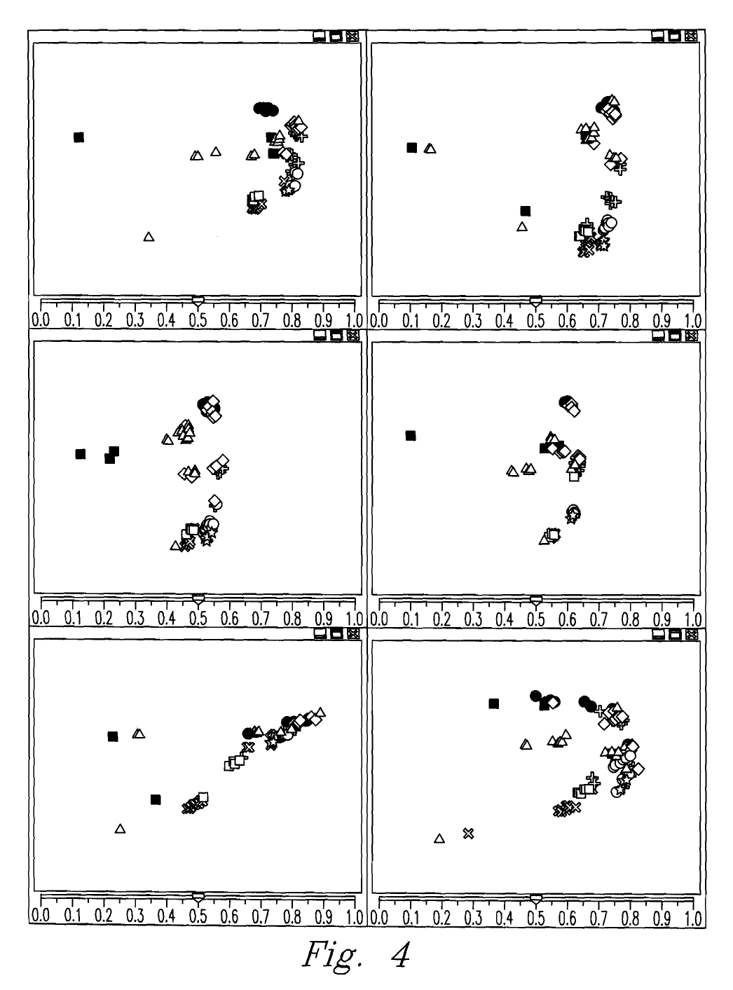

FIG. 4 displays the results of the IN-SPIRE™ analysis of the six fusion strategies for η=0.5. It shows that solutions greatly differ. The human impact is critical, confirming the need of a fusion framework. Furthermore, the transition from the first to the fifth solution is not observed. Hence, we cannot assume that in this setting small changes in the algorithms will always result in small changes in the solutions. Some variants have a greater impact than others at η=0.5. The middle left variant has almost no effect on the IN-SPIRET™ solution, given the distribution in the clusters. Furthermore, dynamically changing the value of η using the slider at the bottom of each plot reveals that some solutions are robust with respect to the choice of η while others change greatly. Outliers and cluster memberships differ between solutions. Some clusters are less affected than others by the enrichment. These clusters tend to have large documents with fewer entities. No pattern in the solutions can be associated with the levels of the taxonomy, e.g. the analytics enrichment solution does not stand out as different from the other solutions. Finally, regarding the focus problem, the analytics enrichment yielded the best changes. The others seemed to be too much affected by the disparate sizes of the entity-based signatures. Furthermore, it improved the IN-SPIRE™ metric, introducing expected correlations between the concepts of that signature. For example, the following correlations were found: Corr(“East”, “West”)=−0.87. Corr(“Manila”, “East”)=0.94, Corr(“Manila”, “West”)=−0.84, Corr(“JI”, “al-Qaeda”)=1.

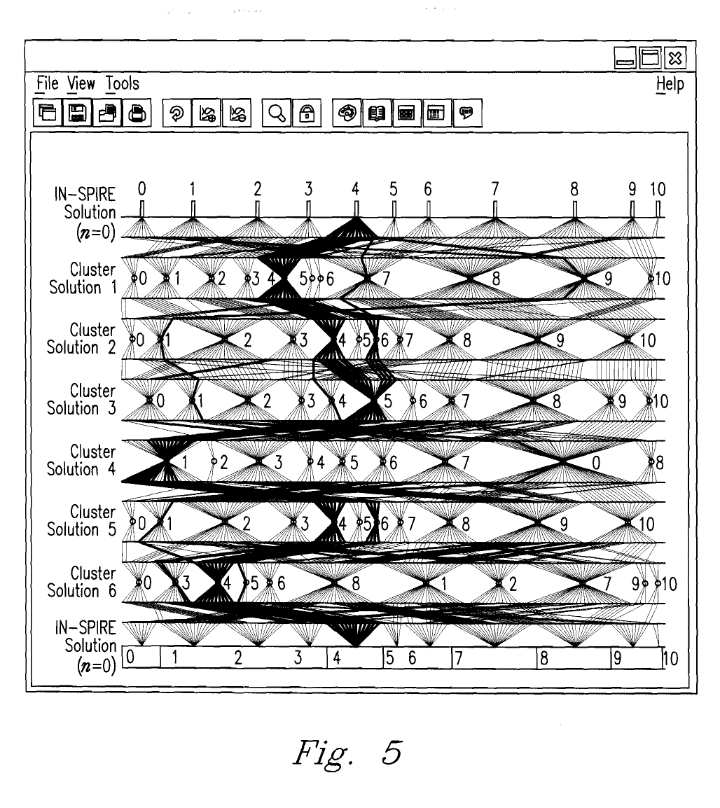

FIG. 5 displays a Juxter graph showing a side-by-side comparison of cluster memberships resulting from the IN-SPIRE™ analysis of the six fusion strategies for η=0.5 (i.e., cluster solutions 1-6), and the original IN-SPIRE™ solution (η=0). The original IN-SPIRE™ solution is shown in the top-most and bottom-most rows. Each of the other rows corresponds to a particular cluster solution. Documents are represented by the curves joining the groups to which they belong in the different clustering solutions. The dark curve highlights the change, between fusion strategies, in cluster membership of documents originally clustered in group 4 of the original IN-SPIRE solution. The Juxter graph reveals that cluster memberships are much more robust with respect to the particular enrichment strategy than signature locations. Indeed, documents within a given cluster tend to have similar trajectories in the plot. Furthermore, all clusters solutions are close to the original cluster solution, which are shown at the top and bottom coordinates of the Juxter plot.

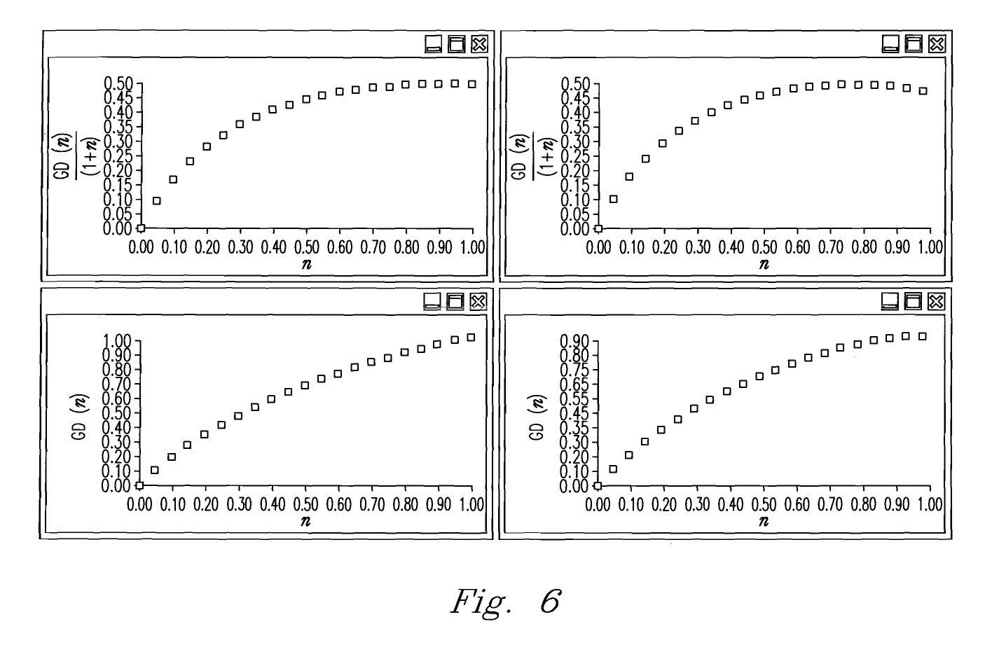

Finally, FIG. 6 compares the triplet (GDmax, η*, GD(q*)/(1+η*)) for the second and fourth enrichments. The GD(η)/(1+η) curves are on the top row and the GD(η) curves are on the bottom. The curves for the second enrichment are on the left column and the curves for the fourth enrichment are on the right. The plot shows that the second strategy makes more use of the enrichment since it has a larger value of GD(η*)/(1+η*) (0.499 vs. 0.475). Moreover, it has a larger value of η*, close to 1, suggesting that the enrichment does not saturate or overwhelm the original signatures.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented method of reasoning about information fusion approaches, the method comprising:
selecting one or more information fusion approaches for evaluation, wherein said selecting is based on a taxonomy that classifies information fusion algorithms;
applying one or more of the selected information fusion approaches to two or more sets of data, and
conveying to a user the impact of each of the applied information fusion approaches, wherein the conveyed impact is based on one or more impact measures.

2. The computer-implemented method as recited in claim 1, wherein at least a portion of the data comprises information selected from the group consisting of sensor data, text-based correspondence, communication transcripts, news articles, intelligence reports, imagery, and maps.

3. The computer-implemented method as recited in claim 1, wherein at least a portion of the data comprises computer-processable information characterized by one or more information analysis techniques.

4. The computer-implemented method as recited in claim 3, wherein at least a portion of the data comprises data signatures.

5. The computer-implemented method as recited in claim 3, wherein the information analysis techniques comprise visual analytics techniques.

6. The computer-implemented method as recited in claim 1, wherein said selecting is automated, user-assisted, user-determined, or combinations thereof.

7. The computer-implemented method as recited in claim 1, wherein said selecting is further based on the pedigrees of the data.

8. The computer-implemented method as recited in claim 1, wherein the taxonomy comprises one or more fusion processes, wherein fusion processes are classes of fusion algorithms.

9. The computer-implemented method as recited in claim 8, wherein the taxonomy comprises one or more fusion algorithms, wherein fusion algorithms are classes of fusion implementation variants.

10. The computer-implemented method as recited in claim 8, wherein the taxonomy further comprises symmetric and asymmetric data classes, wherein the symmetric and asymmetric classes are different classes of fusion processes.

11. The computer-implemented method as recited in claim 10, wherein fusion processes associated with the symmetric data class comprise data fusion, feature fusion, and decision fusion processes.

12. The computer-implemented method as recited in claim 10, wherein fusion processes associated with the asymmetric dataset class comprise data enrichment and analytics enrichment processes.

13. The computer-implemented method as recited in claim 1, wherein said applying comprises traversing the taxonomy along a path of associated classes to a fusion implementation variant of a particular fusion algorithm, and applying to the data the fusion implementation variant of the particular fusion algorithm.

14. The computer-implemented method as recited in claim 1, wherein said applying comprises varying the degree of enrichment when employing asymmetric fusion or varying the degree of mixing when employing symmetric fusion.

15. The computer-implemented method as recited in claim 14, wherein said varying the degree of enrichment or the degree of mixing comprises applying a parameter to one or more analytical operators or to at least one of the sets of data.

16. The computer-implemented method as recited in claim 14, wherein an optimal enrichment produces the maximum impact, based on one or more impact measures, at the minimum degree of enrichment.

17. The computer-implemented method as recited in claim 1, wherein said conveying comprises conveying substantially in parallel the impact of a plurality of information fusion approaches.

18. The computer-implemented method as recited in claim 1, wherein said conveying occurs substantially in real-time relative to said applying.

19. The computer-implemented method as recited in claim 1, wherein the impact measures comprise numeric criteria, visual criteria, or both.

20. The computer-implemented method as recited in claim 1, wherein said conveying comprises generating visual representations of the impact.

21. The computer-implemented method as recited in claim 20, wherein the visual representations are dynamic or static.

22. The computer-implemented method as recited in claim 1, further comprising fusing the sets of data using one of the information fusion approaches.

23. The computer-implemented method as recited in claim 22, wherein the fusing results in the optimal impact based on the impact measures.

24. An apparatus for reasoning about information fusion approaches comprising:
a plurality of information fusion algorithms accessible by processing circuitry, wherein the information fusion algorithms are classified according to a taxonomy;
two or more sets of data accessible by processing circuitry; and
processing circuitry configured to:
select one or more information fusion approaches for evaluation, wherein the selection is based on the taxonomy of information fusion algorithms;
apply one or more of the selected information fusion approaches to at least two of the sets of data;
convey to a user through a user interface the impact of the application of the fusion approaches, wherein the conveyed impact is based on one or more impact measures; and
process input received from a user through an input device.

25. The apparatus as recited in claim 24, wherein at least a portion of the data comprises computer-processable information characterized by one or more information analysis techniques.

26. The apparatus as recited in claim 24, wherein the conveyance of the impact comprises generation of a visualization that is displayed to the user on a display device.
